(19) United States
(12) Patent Application Publication
(10) Pub. No.: US 2022/0258947 A1
(43) Pub. Date: Aug. 18, 2022

(54) Protective Packaging for Shipping Items

(71) Applicant: Ricardo Ramirez, Pharr, TX (US)

(72) Inventor: Ricardo Ramirez, Pharr, TX (US)

(21) Appl. No.: 17/305,660

(22) Filed: Jul. 12, 2021

Related U.S. Application Data
(60) Provisional application No. 63/149,353, filed on Feb. 14, 2021.

(51) Int. Cl. B65D 81/113; A45C 11/18; A45C 13/00; B65D 77/04; A63F 1/10; A63F 1/06

(52) U.S. Cl. CPC B65D 81/113; A45C 11/18; A45C 13/002; B65D 2581/052; A63F 1/10; A63F 1/062; B65D 77/0413

(57) ABSTRACT

Various embodiments include apparatus, systems, and methods relating to protective packaging for shipping items. In some embodiments, a protective packaging system may include a shipping container and a foam insert assembly. The shipping container may encase an interior portion. The foam insert assembly may be configured to conformally encapsulate one or more shipping items within the interior portion of the shipping container, e.g., so as to protect the one or more shipping items from mechanical impact damage (e.g., bending) and/or environmental damage (e.g., exposure to moisture) during shipping.

### BACKGROUND

This application claims benefit of priority to U.S. Provisional Application No. 63/149,353, filed Feb. 14, 2021, titled “Protective Packaging for Shipping Items”, which is herein incorporated by reference in its entirety.

### TECHNICAL FIELD

This disclosure relates generally to protective packaging for shipping items.

### DESCRIPTION OF THE RELATED ART

Various easily damaged items, such as trading cards, may be cumbersome to package and are often shipped with inadequate protection. Some trading cards may be stored within protective covers, such as sleeves, topload card holders (also known as a “toploaders”), and/or slabs (such as those from card grading services). Trading cards, with or without the protective covers, are often shipped sandwiched between two pieces of cardboard that were manually cut out from a cardboard box. Tape may be used to hold the trading card(s) in place between the pieces of cardboard, so that the cardboard provides reinforcement intended to avoid bending of the trading card(s) during shipping. Furthermore, these items may be placed within a bubble wrap mailer in some cases.

In many instances in which trading cards packaged in such a manner, the cards are received by collectors in a damaged condition (e.g., due to bending, corner damage, scratches, and/or exposure to environmental elements during shipping), and in some cases, even minor damage may devalue a trading card by hundreds or even thousands of dollars. Additionally, the various steps used in the aforementioned packaging technique may be cumbersome (from the sender's perspective), inelegant, and/or difficult to unpack (from the recipient's perspective).

### BRIEF DESCRIPTION OF THE DRAWINGS

FIGS. 1A-1B illustrate views of an example protective packaging system for one or more shipping items, in accordance with some embodiments. FIG. 1A shows a perspective view of the protective packaging system including a foam insert assembly that is in an assembled state. FIG. 1B shows another perspective view of a portion of the protective packaging system, with the foam insert assembly in a partially unassembled state. As indicated in FIG. 1B, the protective packaging system may be configured to ship a trading card (e.g., a graded card in a protective “slab”) while protecting the trading card from damage during shipping.

FIGS. 2A-2B illustrate views of an example foam insert assembly that may be included in a protective packaging system, in accordance with some embodiments. FIG. 2A shows a perspective view of the foam insert assembly in an assembled state. FIG. 2B shows another perspective view of the foam insert assembly in a partially unassembled state.

FIG. 3 illustrates a top perspective view of an example foam insert assembly that may be included in a protective packaging system, in accordance with some embodiments. The foam insert assembly is shown in a partially unassembled state. FIG. 3 also includes a schematic diagram of an example shipping item, which the foam insert assembly may be configured to receive and cover in various embodiments.

FIGS. 4A-4B illustrate views of an example protective packaging system for one or more shipping items, in accordance with some embodiments. FIG. 4A shows a schematic top view of the protective packaging system in an assembled state. FIG. 4B shows a schematic side cross-sectional view of the protective packaging system in an assembled state.

FIG. 5 illustrates a schematic side view of an example foam insert assembly that may be included in a protective packaging system, in accordance with some embodiments.

FIG. 6 illustrates a schematic side view of another example foam insert assembly that may be included in a protective packaging system, in accordance with some embodiments.

FIG. 7 illustrates an example process flow for shipping one or more shipping items using a protective packaging system, in accordance with some embodiments.

FIG. 8 is a flowchart of an example method of constructing a protective packaging system, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units or other components may be described or claimed as “configured to” perform a task or tasks. In such contexts, “configured to” is used to connote structure by indicating that the units or components include structure that performs those task or tasks during operation. As such, the unit or component can be said to be configured to perform the task even when the specified unit or component is not currently operational (e.g., is not on). The units/circuits/components used with the “configured to” language include hardware—for example, circuits, memory storing program instructions executable to implement the operation, etc. Reciting that a unit or component is “configured to” perform one or more tasks is expressly intended not to invoke 35 U.S.C. § 112(f) for that unit or component. Additionally, “configured to” can include generic structure that is manipulated by software and/or firmware to operate in manner that is capable of performing the task(s) at issue. “Configure to” may also include adapting a manufacturing process to fabricate devices that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

Various embodiments include apparatus, systems, and methods relating to protective packaging for shipping items are disclosed. In some embodiments, a protective packaging system may include a shipping container and a foam insert assembly. A plurality of walls of the shipping container may encase an interior portion of the shipping container. The foam insert assembly may be configured to conformally encapsulate one or more shipping items within the interior portion of the shipping container, e.g., so as to protect the one or more shipping items from mechanical impact damage (e.g., bending, scratching, or crushing) and/or environmental damage (e.g., exposure to moisture) during shipping. According to some embodiments, the foam insert assembly may be constructed, wholly or in part, from polyurethane-based foam or other materials suitable for surrounding delicate items during shipping, as one having ordinary skill in the art would understand.

According to some embodiments, the shipping container may include a top wall, a bottom wall opposite the top wall, and side walls that extend from the bottom wall to the top wall in a thickness dimension (which may be the smallest dimension of the shipping container in various examples). According to some embodiments, the shipping container may be made entirely or partially from die-cut non-corrugated cardboard. In some embodiments, non-corrugated cardboard may be chosen over corrugated cardboard in order to allow for greater protection against moisture entering the interior portion of the shipping container.

In some embodiments, the foam insert assembly may include one or more core foam inserts and a frame foam insert. The core foam insert(s) may be respectively configured to cover a respective side of the shipping item(s), e.g., a respective side parallel to the top wall of the shipping container. In some embodiments, the frame foam insert may define an inner cutout sized to accommodate therein the shipping item(s) and the core foam insert.

According to some embodiments, the frame foam insert may include a plurality of pre-perforated sections that may be selectively removed by a user in order to form one or more inner cutouts according to the specific size of the item or items to be packaged. For example, a plurality of pre-perforated squares or rectangles may be selectively removed to size such inner cutouts appropriately.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, and components have not been described in detail so as not to unnecessarily obscure aspects of the embodiments.

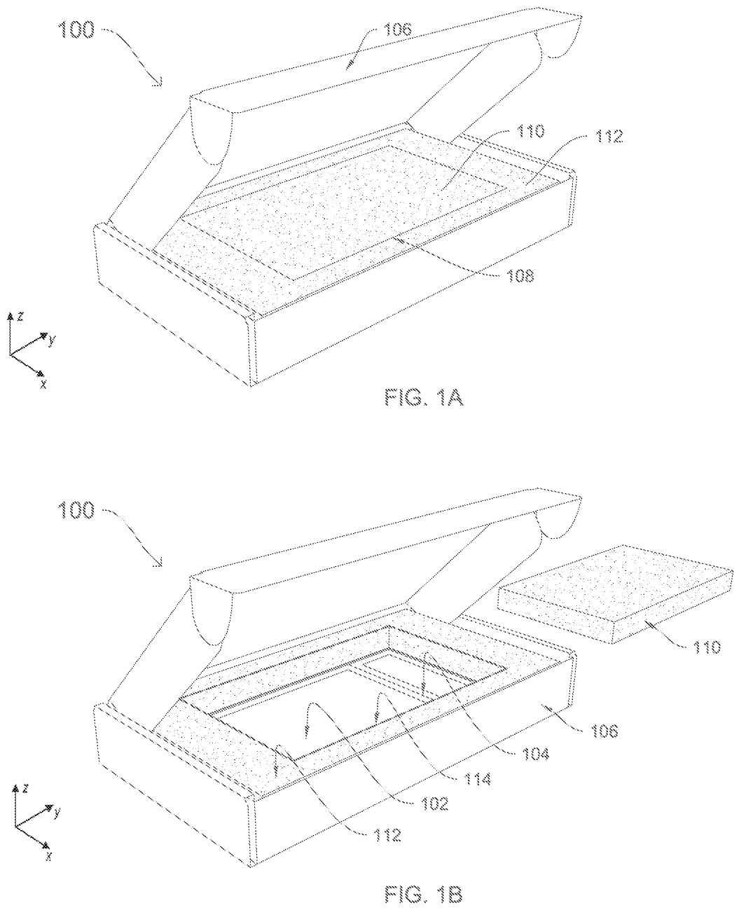

FIGS. 1A-1B illustrate views of an example protective packaging system 100 for one or more shipping items, in accordance with some embodiments. FIG. 1A shows a perspective view of the protective packaging system 100 including a foam insert assembly that is in an assembled state. FIG. 1B shows another perspective view of a portion of the protective packaging system 100, with the foam insert assembly in a partially unassembled state. As indicated in FIG. 1B, the protective packaging system may be configured to ship a trading card 102 (e.g., a graded card in a protective “slab” 104) while protecting the trading card 102 from damage during shipping.

In various embodiments, the protective packaging system 100 may include a shipping container 106 and a foam insert assembly 108. The shipping container 106 may encase an interior portion. The foam insert assembly may be configured to conformally encapsulate one or more shipping items (e.g., trading card 102 and/or slab 104, etc.) within the interior portion of the shipping container 106, e.g., so as to protect the one or more shipping items from mechanical impact damage (e.g., bending) and/or environmental damage (e.g., exposure to moisture) during shipping.

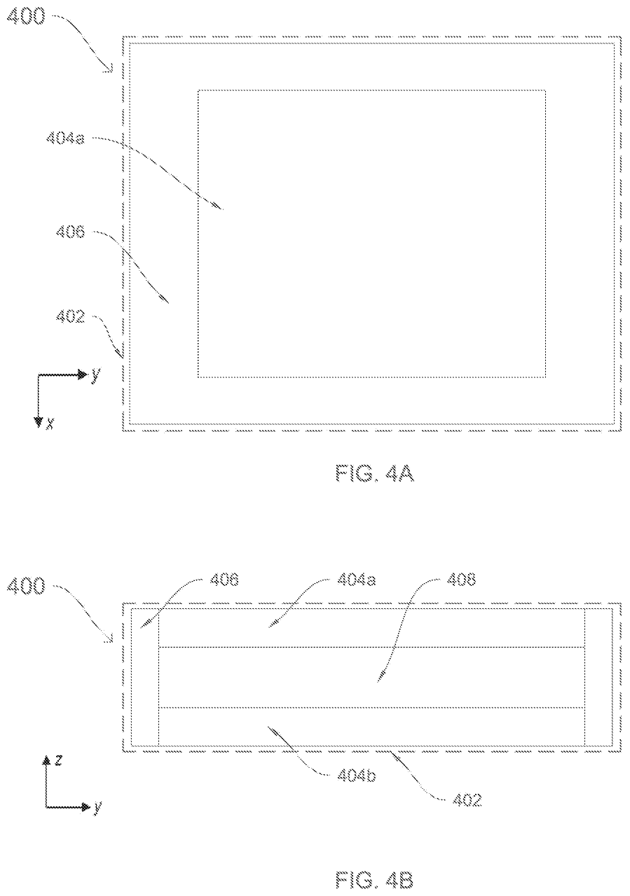

According to some embodiments, the shipping container 106 may include a top wall, a bottom wall opposite and substantially parallel the top wall when the shipping container is closed, and side walls that extend from the bottom wall to the top wall in a thickness dimension (which may be the smallest dimension of the shipping container in various examples), e.g., as discussed herein with reference to FIG. 4B. In the example of FIG. 1A, the bottom wall is within an X-Y plane while two of the side walls of the shipping container occupy X-Z planes parallel to each other and the other two side walls occupy Y-Z planes parallel to each other.

In some embodiments, the foam insert assembly 108 may include one or more core foam inserts 110 and a frame foam insert 112. The core foam insert(s) 110 may be respectively configured to cover a respective side of the shipping item(s), e.g., a respective side parallel to the top wall of the shipping container 106.The frame foam insert 112 may define an inner cutout sized to accommodate therein the shipping item(s) and the core foam insert. For example, FIG. 1B indicates an example cutout periphery 114 using dashed lines. According to some embodiments, all or a portion of the foam insert assembly is placed within the interior of the shipping container in an X-Y plane parallel to the bottom and top walls of the shipping container.

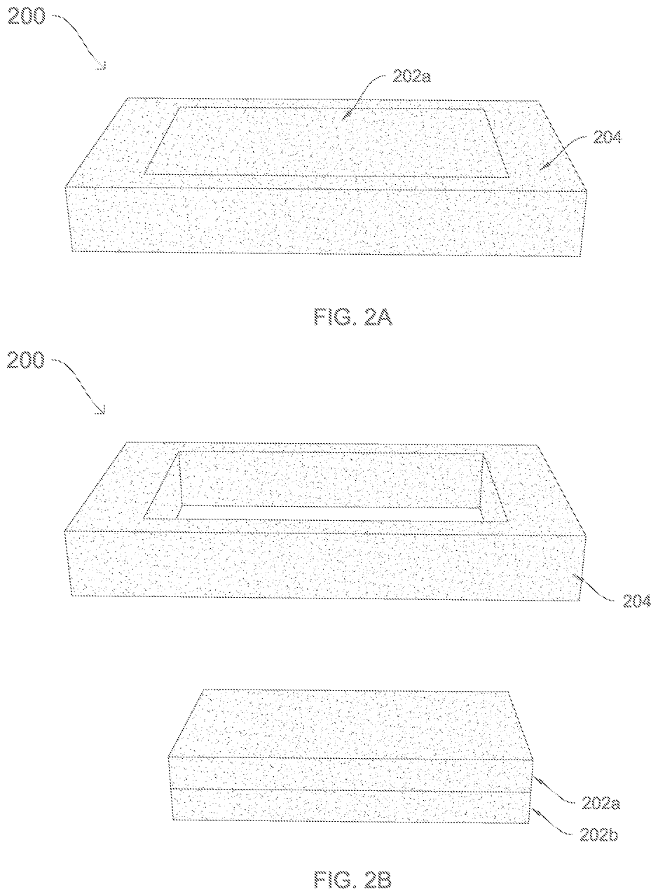

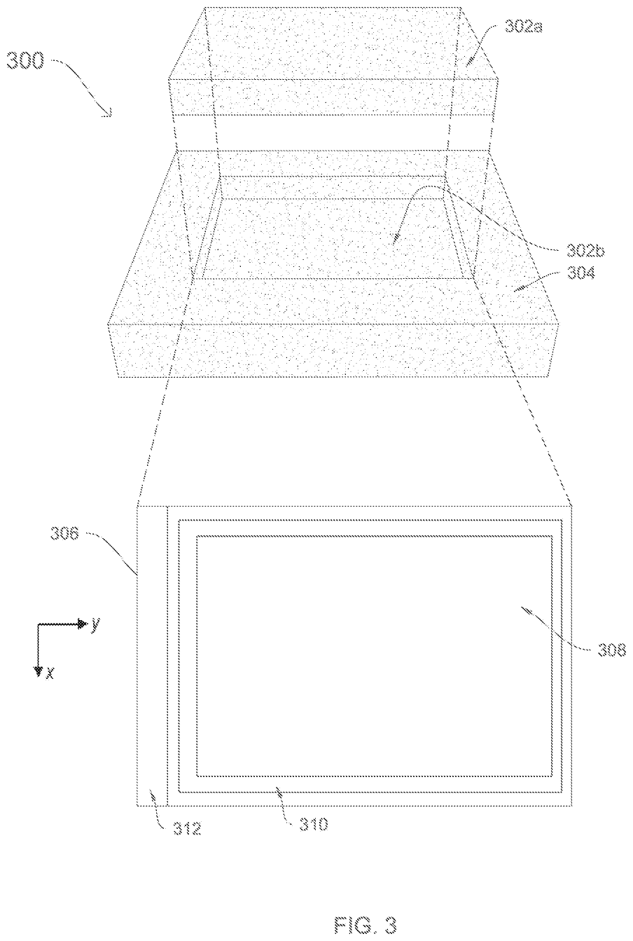

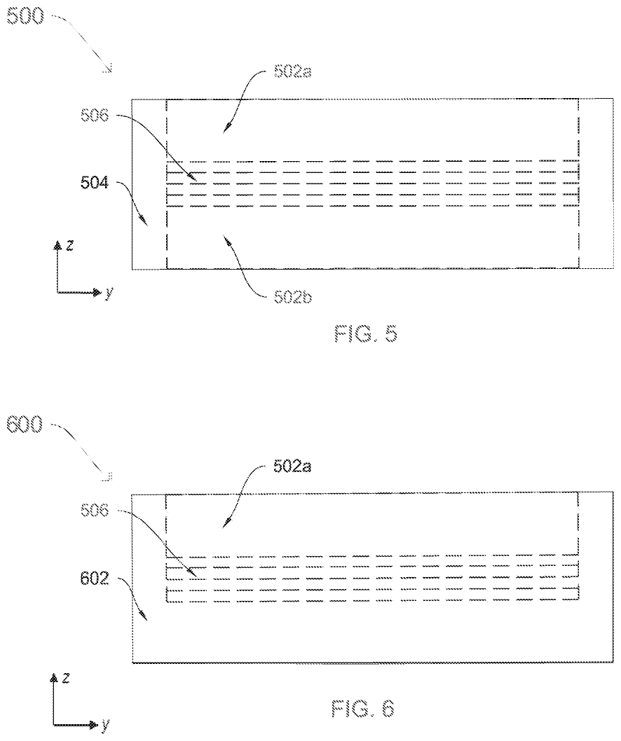

In some embodiments, the core foam insert(s) 110 may include a pair of core foam inserts 110 that sandwich the shipping item(s). For example, in FIG. 1B a “top” core foam insert 110 is shown unassembled from the frame foam insert 112, such that the foam insert assembly 108 is in a partially unassembled state. A corresponding “bottom” core foam insert (not shown) may be disposed within the interior portion of the shipping container 106, below the shipping item(s) (e.g., trading card 102 and/or slab 104, etc.), and/or at least partially encircled by the frame foam insert 112, e.g., as indicated in FIGS. 2B, 3, 4B, and 5. However, it should be appreciated that in some embodiments the inner cutout of the frame foam insert 112 may comprise a recess, such that the frame foam insert 112 itself provides a foam bottom positioned below the shipping item(s), e.g., as indicated in FIG. 6.

In various embodiments, the shipping item(s) may include one or more cards, e.g., trading card(s) and/or collectible card(s). However, the shipping item(s) may include other types of items in some embodiments. For example, such items may include, but are not limited to, thin, flat, collectible, high-value, and/or fragile items in some examples. In some non-limiting embodiments, the shipping item(s) may include comic book(s), stamp(s), paper currency, coin(s), photograph(s), art (e.g., painting(s)), etc.

FIGS. 2A-2B illustrate views of an example foam insert assembly 200 (e.g., foam insert assembly 108 in FIGS. 1A-1B) that may be included in a protective packaging system (e.g., protective packaging system 100 in FIGS. 1A-1B), in accordance with some embodiments. FIG. 2A shows a perspective view of the foam insert assembly 200 in an assembled state. FIG. 2B shows another perspective view of the foam insert assembly 200 in a partially unassembled state. In various embodiments, the foam insert assembly 200 may be configured to fit within a shipping container (e.g., shipping container 106 in FIGS. 1A-1B).

In some embodiments, the foam insert assembly 200 may include a top core foam insert 202a, a bottom core foam insert 202b, and a frame foam insert 204. One or more shipping items (e.g., trading card(s)) (not shown in FIGS. 2A-2B) may be placed between the top core foam insert 202a and the bottom core foam insert 202b to form a stackup of layers in a direction of a height of the frame foam insert 204 and/or a thickness dimension of the shipping container. In various examples, a height of such a stackup (including the core foam inserts and the shipping item(s)) may substantially match the height of the frame foam insert 204 and/or the thickness dimension of the shipping container. The foam insert assembly 200 may be toleranced so as to mitigate movement of the shipping item(s) relative to the shipping container when the protective packaging system is assembled (e.g., during shipping).

According to some embodiments, the foam insert assembly may be constructed, wholly or in part, from polyurethane-based foam or other materials suitable for surrounding delicate items during shipping, as one having ordinary skill in the art would understand. The various components of the foam insert assembly may be pre-cut according to some embodiments. According to other embodiments, a user may custom-cut portions foam insert assembly according to the sizes of items to be shipped. In still further embodiments, all or a portion of the foam insert assembly may be supplied with perforations to allow easy removal of sections in order to customize the size and shape of the insert assembly itself and/or cutout interior portions of the assembly in order to allow for custom sizing based on the item or items to be shipped.

FIG. 3 illustrates a top perspective view of an example foam insert assembly 300 that may be included in a protective packaging system (e.g., protective packaging system 100 in FIGS. 1A-1B), in accordance with some embodiments. In the illustration of FIG. 3, the assembly sits in an X-Y plane and is viewed from the top, looking along a Z-axis. The foam insert assembly 300 is shown in a partially unassembled state. According to various embodiments, the foam insert assembly 300 may include a top core foam insert 302a, a bottom core foam insert 302b, and a frame foam insert 304.

FIG. 3 also includes a schematic diagram of an example shipping item(s) 306, which the foam insert assembly 300 may be configured to receive and cover/protect in various embodiments. For example, the shipping item(s) 306 may include a trading card 308, a sleeve 310, and/or a toploader 312. In some embodiments, the trading card 308 may be placed within the sleeve 310 and/or the toploader 312. In some embodiments, the trading card 308 may be placed within the sleeve 310, and the sleeve 310 (containing the trading card 308) may be placed within the toploader 312. According to some embodiments, the trading card 308 may additionally or alternatively be placed within another type of protective cover (e.g., slab 104 in FIG. 1B).

In some non-limiting embodiments, the trading card 308 may have a substantially planar surface with dimensions of approximately 2.5 inches by 3.5 inches. In another non-limiting embodiment, the trading card 308 may have a size of approximately 5 inches by 7 inches. It should be understood, however, that the dimensions of trading cards vary, and thus the dimensions the foam insert assembly 300 and/or the shipping container may also vary based on the dimensions and/or the quantity of items being shipped in the protective packaging system. The trading card's 308 thickness may be the smallest dimension of the card, e.g., a dimension in a direction orthogonal to the planar surface of the trading card 308. In some non-limiting embodiments, the thickness of the trading card 308 may range from about 35 points to about 360 points, where 1,000 points equals 1 inch.

In some non-limiting embodiments, the sleeve 310 may have dimensions that are similar to, or slightly greater than, the trading card 308. In some non-limiting embodiments, the toploader 312 may have dimensions that are greater than the trading card 308 and/or similar to, or slightly greater than, the sleeve 310. In various examples, the sleeve 310 and/or the toploader 312 may comprise an outer sheath of plastic (e.g., polyethylene, polypropylene, polyester, etc.) into which the trading card 308 may be inserted. In some embodiments, the toploader 312 may be more rigid than the sleeve 310.

As used herein, a “slab” (e.g., slab 104 in FIG. 1B) may refer to a hard plastic (e.g., acrylic) holder that encapsulates the shipping item(s) 306. For example, card grading services (e.g., PSA, BGS, SGC, etc.) may return a graded trading card in such a holder, to protect the card and/or provide a desirable form of displaying the card.

FIGS. 4A-4B illustrate views of an example protective packaging system 400 (e.g., protective packaging system 100 in FIGS. 1A-1B) for one or more shipping items, in accordance with some embodiments. FIG. 4A shows a schematic top view of the protective packaging system 400. In the illustration of FIG. 4A, the assembly sits in an X-Y plane and is viewed from the top, looking along a Z-axis.

FIG. 4B shows a schematic side cross-sectional view of the protective packaging system 400. At FIG. 4B the relative positioning of the several components of the foam insert assembly are shown, as discussed in more detail below. In the illustration of FIG. 4B, a Y-Z plane view is illustrated as viewed looking along an X-axis.

In various embodiments, the protective packaging system 400 may include a shipping container 402 (the outline of which is indicated in FIGS. 4A-4B using dashed lines), a foam insert assembly (e.g., comprising top core foam insert 404a and/or bottom core foam insert 404b), and a frame foam insert 406. As indicated in FIG. 4B, shipping item(s) 408 may be encapsulated within the foam insert assembly when packaged within the shipping container 402. While shipping item(s) 408 corresponds to a single block in FIG. 4B, it should be understood that multiple shipping items (e.g., shipping items 506 in FIG. 5) may be included in various embodiments.

FIG. 5 illustrates a schematic side view of an example foam insert assembly 500 that may be included in a protective packaging system (e.g., protective packaging system 100 in FIGS. 1A-1B), in accordance with some embodiments.

In various embodiments, the foam insert assembly 500 may include a top core foam insert 502a, a bottom core foam insert 502b, and a frame foam insert 504. As indicated in FIG. 5, multiple shipping items 506 may be stacked and sandwiched between the top core foam insert 502a and the bottom core foam insert 502b. Furthermore, the shipping items 506 may be encapsulated within a cavity defined by the top core foam insert 502a, the bottom core foam insert 502b, and the frame foam insert 504. In this example, the frame foam insert 504 may define a through-hole cutout for accommodating the top core foam insert 502a, the bottom core foam insert 502b, and the shipping items 506. In the illustration of FIG. 5, the foam insert assembly is viewed from the side, looking along an X-axis at a Y-Z side view of the assembly.

FIG. 6 illustrates a schematic side view of another example foam insert assembly 600 that may be included in a protective packaging system (e.g., protective packaging system 100 in FIGS. 1A-1B), in accordance with some embodiments. In this example, the foam insert assembly 600 may include a top core foam insert 502a and a frame foam insert 602. Instead of the bottom core foam insert 502b shown in FIG. 5, the frame foam insert 504 may provide protective support below the shipping items 506. For example, the frame foam insert 504 may define a recess cutout (e.g., instead of the through-hole cutout in FIG. 5), as indicated in FIG. 6. In the illustration of FIG. 6, the foam insert assembly is viewed from the side, looking along an X-axis at a Y-Z side view of the assembly.

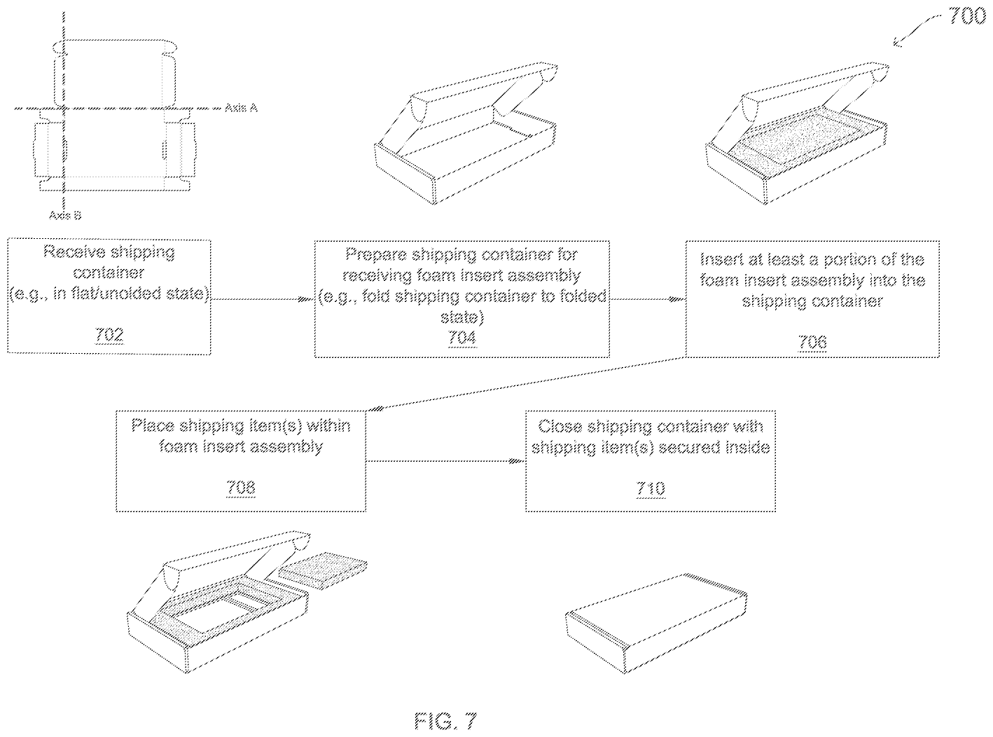

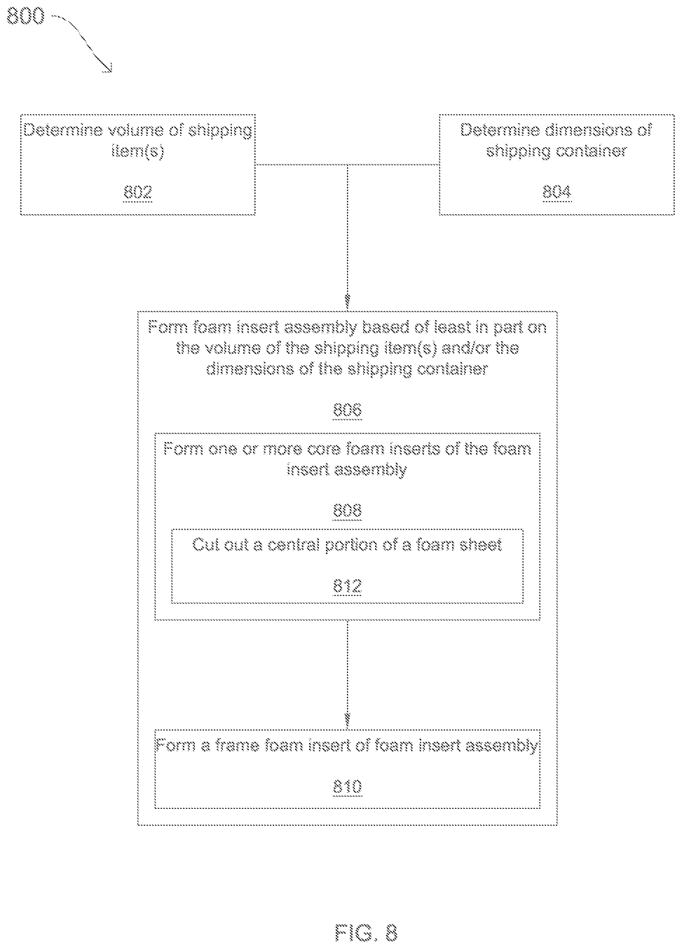

FIG. 7 illustrates an example process flow 700 for shipping one or more shipping items using a protective packaging system (e.g., protective packaging system 100 in FIGS. 1A-1B), in accordance with some embodiments.

At 702, the process flow 700 may include receiving a shipping container (e.g., shipping container 106 in FIG. 1A) of the protective packaging system. In some embodiments, the shipping container may be a box, such as a cardboard box. In some embodiments, the shipping container may be a foldable shipping container, as indicated in FIG. 7. The foldable shipping container may be foldable along multiple different axes in some embodiments. For example, the foldable shipping container may be foldable along Axis A and Axis B, among other fold axes, in the non-limiting embodiment shown in FIG. 7. In some embodiments, the shipping container may be a non-corrugated box.

At 704, the process flow 700 may include preparing the shipping container for receiving a foam insert assembly (e.g., foam insert assembly 108 in FIGS. 1A-1B) of the protective packaging system. For example, preparing the shipping container may include folding the shipping container, e.g., so as to transform it from a flat state (as indicated in 702) to a folded state (as indicated in 704). In the folded state, the shipping container may be configured to receive the foam insert assembly and the shipping item(s).

At 706, the process flow 700 may include inserting at least a portion of the foam insert assembly into the shipping container. At 708, the process flow 700 may include placing one or more shipping items (e.g., a trading card 102 within a slab 104 in FIG. 1B, shipping item(s) 306 in FIG. 3, etc.) within the foam insert assembly. For example, a frame foam insert and a bottom core foam insert may be placed within the shipping container. The shipping item(s) may be placed within the frame foam insert and on the bottom core foam insert. The top core foam insert may be placed on the shipping items and within the frame foam insert.

At 710, the process flow 700 may include closing the shipping container with the shipping item(s) secured inside. For example, the shipping container may be closed and maintained in a closed state using an adhesive (e.g., tape, glue, etc.), a latch, and/or another mechanism suitable for securing the shipping container shut. In various embodiments, when the shipping container is closed, the foam insert assembly and the shipping item(s) have a snug fit within the shipping container, e.g., with an outer contour of the shipping item(s) substantially matching and/or conforming to an interior contour of the foam insert assembly, and with an outer contour of the foam insert assembly substantially matching and/or conforming to an inner contour of the shipping container.

FIG. 8 is a flowchart of an example method 800 of constructing at least part of a protective packaging system (e.g., protective packaging system 100 in FIGS. 1A-1B), in accordance with some embodiments.

At 802, the method 800 may include determining a volume (and/or dimensions) of one or more shipping items. In some embodiments, a volume may be directly measured or estimated by the shipper. In other embodiments, a shipping volume may be calculated. For example, a total shipping volume may be calculated based on quantities of items ordered for known shipping volume characteristics of various stock items in the order.

At 804, the method 800 may include determining dimensions of a shipping container. The shipping container dimensions, in some embodiments, may be based on the volume of items to be shipped as determined at step 802 as well as the volume of protective shipping material required for packaging the items to be shipped.

At 806, the method 800 may include forming a foam insert assembly, e.g., based at least in part on the volume of the shipping item(s) and/or the dimensions of the shipping container. In some embodiments, forming the foam insert assembly may include forming one or more core foam inserts (at 808) and forming a frame foam insert (at block 810). According to various examples, the core foam insert(s) may be formed (at 808) by cutting out a central portion of a foam sheet (at 812).

Additional descriptions of embodiments (example clauses):

Clause 1: A system, comprising: a shipping container that encases an interior portion of the shipping container, the shipping container comprising: a top wall; a bottom wall opposite the top wall; and side walls that extend from the bottom wall to the top wall in a thickness dimension that is the smallest dimension of the shipping container; and a foam insert assembly that conformally encapsulates one or more shipping items within the interior portion of the shipping container so as to protect the one or more shipping items from at least one of mechanical impact damage or environmental damage, wherein the foam insert assembly comprises: one or more core foam inserts that are respectively configured to cover a respective side of the one or more shipping items that is parallel to the top wall of the shipping container; and a frame foam insert defining an inner cutout sized to accommodate therein the one or more shipping items and the one or more core foam inserts.

Clause 2: The system of Clause 1, wherein the one or more core foam inserts comprise: a pair of core foam inserts, wherein: a first foam core insert of the pair of foam core inserts is configured to cover the respective side of the one or more shipping items that is parallel to the top wall of the shipping container; and a second foam core insert of the pair of foam core inserts is configured to cover a respective side of the one or more shipping items that is parallel with the bottom wall of the shipping container.

Clause 3: The system of Clause 1 or Clause 2, wherein the one or more shipping items comprise one or more cards, and wherein a card of the one or more cards is at least one of: a trading card; or a collectible card.

Clause 4: The system of any one of Clauses 1-3, wherein the one or more shipping items further comprise a protective sleeve within which the card is contained.

Clause 5: The system of Clause 4, wherein the one or more shipping items further comprise a topload card holder within which the protective sleeve is contained.

Clause 6: The system of any of Clauses 1-3, wherein the one or more shipping items further comprise a topload card holder within which the card is contained.

Clause 7: The system of any of Clauses 1-6, wherein the one or more shipping items further comprise a graded card slab within which the card is contained.

Clause 8: The system of any of Clauses 1-7, wherein the shipping container comprises cardboard.

Clause 9: The system of any of Clauses 1-8, wherein the shipping container is a foldable shipping container.

Clause 10: The system of Clause 9, wherein the shipping container is foldable along multiple different axes.

Clause 11: The system of any of Clauses 1-10, wherein the shipping container comprises a non-corrugated box.

Clause 12: A method of packaging one or more shipping items, the method comprising: receiving a shipping container in an unprepared state; preparing the shipping container for receiving a foam insert assembly, wherein the prepared shipping container encases an interior portion of the shipping container and the prepared shipping container comprises: a top wall; a bottom wall opposite the top wall; and side walls that extend from the bottom wall to the top wall in a thickness dimension that is the smallest dimension of the shipping container; inserting at least a portion of a foam insert assembly into the shipping container, the foam insert assembly comprising: one or more core foam inserts that are respectively configured to cover a respective side of the one or more shipping items that is parallel to the top wall of the shipping container; and a frame foam insert defining an inner cutout sized to accommodate therein the one or more shipping items and the one or more core foam inserts; placing the one or more shipping items within the foam insert assembly, such that the foam insert assembly conformally encapsulates the one or more shipping items within the interior portion of the shipping container so as to protect the one or more shipping items from at least one of mechanical impact damage or environmental damage; and closing the shipping container with the one or more shipping items secured within the shipping container.

Clause 13: The method of Clause 12, wherein preparing the shipping container for receiving a foam insert assembly comprises making a plurality of folds to the shipping container.

Clause 14: The method of Clause 12 or Clause 13, wherein the shipping container is foldable along multiple axes.

Clause 15: The method of any of Clauses 12-14, wherein the one or more core foam inserts comprise: a pair of core foam inserts, wherein: a first foam core insert of the pair of foam core inserts is configured to cover the respective side of the one or more shipping items that is parallel to the top wall of the shipping container; and a second foam core insert of the pair of foam core inserts is configured to cover a respective side of the one or more shipping items that is parallel with the bottom wall of the shipping container.

Clause 16: The method of any one of Clauses 12-15, wherein the one or more shipping items comprise one or more cards, and wherein a card of the one or more cards is at least one of: a trading card; or a collectible card.

Clause 17: The method of Clause 16, wherein the one or more shipping items further comprise a protective sleeve within which the card is contained.

Clause 18: The method of Clause 16 or 17, wherein the one or more shipping items further comprise a topload card holder within which the card is contained.

Clause 19: A method of constructing a protective packaging system, the method comprising: determining a volume of one or more shipping items; determining required dimensions of a shipping container, the shipping container comprising: a top wall a bottom wall opposite the top wall; and side walls that extend from the bottom wall to the top wall in a thickness dimension that is the smallest dimension of the shipping container; forming a foam insert assembly that conformally encapsulates the one or more shipping items within an interior portion of the shipping container so as to protect the one or more shipping items from at least one of mechanical impact damage or environmental damage, wherein the foam insert assembly comprises: one or more core foam inserts that are respectively configured to cover a respective side of the one or more shipping items that is parallel to the top wall of the shipping container; and a frame foam insert defining an inner cutout sized to accommodate therein the one or more shipping items and the one or more core foam inserts.

Clause 20: The method of Clause 19, wherein the one or more core foam inserts comprise: a pair of core foam inserts, wherein: a first foam core insert of the pair of foam core inserts is configured to cover the respective side of the one or more shipping items that is parallel to the top wall of the shipping container; and a second foam core insert of the pair of foam core inserts is configured to cover a respective side of the one or more shipping items that is parallel with the bottom wall of the shipping container.

Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A system, comprising:
a shipping container that encases an interior portion of the shipping container, the shipping container comprising:
a top wall;
a bottom wall opposite the top wall; and
side walls that extend from the bottom wall to the top wall in a thickness dimension that is the smallest dimension of the shipping container; and
a foam insert assembly that conformally encapsulates one or more shipping items within the interior portion of the shipping container so as to protect the one or more shipping items from at least one of mechanical impact damage or environmental damage, wherein the foam insert assembly comprises:
one or more core foam inserts that are respectively configured to cover a respective side of the one or more shipping items that is parallel to the top wall of the shipping container; and
a frame foam insert defining an inner cutout sized to accommodate therein the one or more shipping items and the one or more core foam inserts.

2. The system of claim 1, wherein the one or more core foam inserts comprise:
a pair of core foam inserts, wherein:
a first foam core insert of the pair of foam core inserts is configured to cover the respective side of the one or more shipping items that is parallel to the top wall of the shipping container; and
a second foam core insert of the pair of foam core inserts is configured to cover a respective side of the one or more shipping items that is parallel with the bottom wall of the shipping container.

3. The system of claim 1, wherein the one or more shipping items comprise one or more cards, and wherein a card of the one or more cards is at least one of:
a trading card; or
a collectible card.

4. The system of claim 3, wherein the one or more shipping items further comprise:
a protective sleeve within which the card is contained.

5. The system of claim 4, wherein the one or more shipping items further comprise:
a topload card holder within which the protective sleeve is contained.

6. The system of claim 3, wherein the one or more shipping items further comprise:
a topload card holder within which the card is contained.

7. The system of claim 3, wherein the one or more shipping items further comprise:
a graded card slab within which the card is contained.

8. The system of claim 1, wherein the shipping container comprises cardboard.

9. The system of claim 1, wherein the shipping container is a foldable shipping container.

10. The system of claim 9, wherein the foldable shipping container is foldable along multiple different axes.

11. The system of claim 10, wherein shipping container comprises a non-corrugated box.

12. A method of packaging one or more shipping items, the method comprising:
receiving a shipping container in an unprepared state;
preparing the shipping container for receiving a foam insert assembly, wherein the prepared shipping container encases an interior portion of the shipping container and the prepared shipping container comprises:
a top wall;
a bottom wall opposite the top wall; and
side walls that extend from the bottom wall to the top wall in a thickness dimension that is the smallest dimension of the shipping container;
inserting at least a portion of a foam insert assembly into the shipping container, the foam insert assembly comprising:
one or more core foam inserts that are respectively configured to cover a respective side of the one or more shipping items that is parallel to the top wall of the shipping container; and
a frame foam insert defining an inner cutout sized to accommodate therein the one or more shipping items and the one or more core foam inserts;
placing the one or more shipping items within the foam insert assembly, such that the foam insert assembly conformally encapsulates the one or more shipping items within the interior portion of the shipping container so as to protect the one or more shipping items from at least one of mechanical impact damage or environmental damage; and
closing the shipping container with the one or more shipping items secured within the shipping container.

13. The method of claim 12, wherein preparing the shipping container for receiving a foam insert assembly comprises making a plurality of folds to the shipping container.

14. The method of claim 13, wherein the shipping container is foldable along multiple axes.

15. The method of claim 12, wherein the one or more core foam inserts comprise:
a pair of core foam inserts, wherein:
a first foam core insert of the pair of foam core inserts is configured to cover the respective side of the one or more shipping items that is parallel to the top wall of the shipping container; and
a second foam core insert of the pair of foam core inserts is configured to cover a respective side of the one or more shipping items that is parallel with the bottom wall of the shipping container.

16. The method of claim 12, wherein the one or more shipping items comprise one or more cards, and wherein a card of the one or more cards is at least one of:
a trading card; or
a collectible card.

17. The method of claim 16, wherein the one or more shipping items further comprise:
a protective sleeve within which the card is contained.

18. The method of claim 16, wherein the one or more shipping items further comprise:
a topload card holder within which the card is contained.

19. A method of constructing a protective packaging system, the method comprising:
determining a volume of one or more shipping items;
determining required dimensions of a shipping container, the shipping container comprising:
a top wall
a bottom wall opposite the top wall; and
side walls that extend from the bottom wall to the top wall in a thickness dimension that is the smallest dimension of the shipping container;
forming a foam insert assembly that conformally encapsulates the one or more shipping items within an interior portion of the shipping container so as to protect the one or more shipping items from at least one of mechanical impact damage or environmental damage, wherein the foam insert assembly comprises:
one or more core foam inserts that are respectively configured to cover a respective side of the one or more shipping items that is parallel to the top wall of the shipping container; and
a frame foam insert defining an inner cutout sized to accommodate therein the one or more shipping items and the one or more core foam inserts.

20. The method of claim 19, wherein the one or more core foam inserts comprise:
a pair of core foam inserts, wherein:
a first foam core insert of the pair of foam core inserts is configured to cover the respective side of the one or more shipping items that is parallel to the top wall of the shipping container; and
a second foam core insert of the pair of foam core inserts is configured to cover a respective side of the one or more shipping items that is parallel with the bottom wall of the shipping container.
